(19) United States
(12) Patent Application Publication
(10) Pub. No.: US 2007/0076219 A1
(43) Pub. Date: Apr. 5, 2007

(54) Optical tomography system

(75) Inventor: Masahiro Toida, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/529,234

(22) Filed: Sep. 29, 2006

(30) Foreign Application Priority Data
Sep. 30, 2005 (JP) 289121/2005

(51) Int. Cl. G01B 9/02; G01B 11/02

(52) U.S. Cl. 356/511; 356/479; 356/497

(57) ABSTRACT

In an optical coherence tomography measurement, a controller switches between a measurement initiating position adjusting mode in which the position in the direction of depth of the object in which a tomographic image signal is to be obtained is adjusted and a tomographic image obtaining mode in which a tomographic image of the object is to be obtained. In the image obtaining mode, the tomographic image is obtained from the interference light by the first low coherence light and in the measurement initiating position adjusting mode, the tomographic image is obtained from the interference light by the second low coherence light.

### BACKGROUND OF THE INVENTION

1. Field of the Invention

This invention relates to an optical tomography system for obtaining an optical tomographic image by measurement of OCT (optical coherence tomography).

2. Description of the Related Art

As a system for obtaining a tomographic image of an object of measurement in a body cavity, there has been known an ultrasonic tomography system. In addition to such an ultrasonic tomography system, there has been proposed an optical tomography system where an optical tomographic image is obtained on the basis of an interference of light by low coherence light. See, for instance, Japanese Unexamined Patent Publication No. 2003-172690. In the system disclosed in Japanese Unexamined Patent Publication No. 2003-172690, an optical tomographic image is obtained by measuring TD-OCT (time domain OCT) and the measuring light is guided into the body cavity by inserting a probe into the body cavity from the forceps port of an endoscope by way of a forceps channel.

More specifically, low coherence light emitted from a light source is divided into measuring light and reference light and the measuring light is projected onto the object of measurement, while the reflected light from the object of measurement is led to a multiplexing means. The reference light is led to the multiplexing means after its optical path length is changed. By the multiplexing means, the reflected light and the reference light are superposed one on another, and interference light due to the superposition is detected by, for instance, heterodyne detection. In the TD-OCT measurement, a phenomenon that interference light is detected when the optical path of the measuring light conforms to the optical path of the reference light in length is used and the measuring position (the depth of measurement) in the object is changed by changing the optical path length of the reference light.

When measuring the OCT by inserting a probe into a body cavity, the probe is mounted on the system body to be demountable since disinfection, cleaning and the like of the probe after use are necessary. That is, a plurality of probes are prepared for one optical tomography system and the probes are changed by the measurement. However there is an individual difference in the length of the optical fiber due to the manufacturing errors and the like, and the optical path length of the measuring light can change each time the probe is changed. Accordingly, in Japanese Unexamined Patent Publication No. 2003-172690, on the basis of the reflected light from the inner surface of a tube (sheath) covering an optical fiber of the probe, the optical path length of the reference light is adjusted to conform to the optical path length of the measuring light.

Whereas, as a system for rapidly obtaining a tomographic image without changing the optical path length of the reference light such as disclosed in Japanese Unexamined Patent Publication No. 2003-172690, there have been proposed optical tomography systems of obtaining an optical tomographic image by spatially or time dividing the interference light (See, for instance, U.S. Pat. No. 5,565,986 or Japanese Unexamined Patent Publication No. 11(1999)-082817). Among those, a SD-OCT (source domain OCT) system where the frequency of light emitted from a light source is spatially divided to detect the interference light altogether has been proposed. In the SD-OCT system, a tomographic image is formed without scanning in the direction of depth, by emitting broad band, low coherence light from a light source by the use of a Michelson interferometer, dividing the low coherence light into measuring light and reference light and carrying out a Fourier analysis on each signal of channeled spectrum obtained by decomposing the interference light of the reflected light, which returns when projecting the measuring light onto the object, and the reference light into frequency components.

### SUMMARY OF THE INVENTION

In the SD-OCT measurement, it is not necessary to conform the optical path length of the measuring light to that of the reference light since information on the reflection in positions in the direction of depth can be obtained by carrying out frequency-analysis. However, actually, there arises a problem that when the optical path length difference becomes large, the spatial frequency of the interference signal is enlarged and the S/N of the detected interference deteriorates due to limitation on the number of the arrays of the sensor array such as of CCDs for detecting the interference light. Accordingly, also in the SD-OCT measurement, it is still necessary to adjust the optical path length so that the optical path length of the measuring light conforms to that of the reference light and the object S is positioned in the measurable range.

Further since the measurable range over which a tomographic image is obtainable by the SD-OCT measurement is limited in the direction of depth, it is necessary to adjust the optical path length of the reference light according to the distance between the probe and the object in order to adjust the measurement initiating position so that the object S is positioned in the measurable range. That is, in the SD-OCT measurement, it is necessary to adjust the measurement initiating position so that the object S is positioned in the measurable range in addition to that the optical path length must be adjusted in order to accommodate the individual difference of the probe such as shown in Japanese Unexamined Patent Publication No. 2003-172690.

Since in the TD-OCT measurement, the measuring depth is changed by adjusting the optical path length of the reference light, the measurable range can be adjusted by adjusting the optical path length while observing the intensities or the waveforms of the signals obtained by a beat signal measurement or the interferogram measurement of the interference light. However, since in the SD-OCT measurement, the reflection information cannot be obtained unless frequency-analysis such as Fourier-transform is carried out on the detected interference light and when the position of the object is confirmed to adjust the measurement initiating position, frequency-analysis is required, it takes a long time to adjust the measurement initiating position.

In view of the foregoing observations and description, the primary object of the present invention is to provide an optical tomography system in which the adjustment of the measurement initiating position can be carried out in a short time.

In accordance with the present invention, there is provided an optical tomography system for obtaining a tomographic image of an object to be measured comprising

a light source unit provided with a first light source which emits first low coherence light and a second light source which emits second low coherence light which is longer in the coherence length than the first low coherence light emitted from the first light source,

a light dividing means which divides the first or second low coherence light emitted from the light source unit into measuring light and reference light,

an optical path length adjusting means which adjusts the optical path length of the measuring light or the reference light divided by the light dividing means,

a multiplexing means which multiplexes the reflected light from the object when the measuring light divided by the light dividing means is projected onto the object and the reference light,

an interference light detecting means which detects interference light of the reflected light and the reference light which have been multiplexed by the multiplexing means,

a tomographic image obtaining means which detects intensities of reflection of the measuring light in positions in the direction of depth of the object by carrying out frequency-analysis on the interference light detected by the interference light detecting means and obtains a tomographic image of the object, and

a control means which switches between a measurement initiating position adjusting mode in which the position in the direction of depth of the object in which tomographic image signal is to be obtained is adjusted and a tomographic image obtaining mode in which a tomographic image of the object is to be obtained,

wherein the improvement comprises that

the control means controls the light source unit to emit the first low coherence light and the tomographic image obtaining means to obtain the tomographic image from the interference light generated by the first low coherence light in the image obtaining mode and controls the light source unit to emit the second low coherence light and the tomographic image obtaining means to obtain the tomographic image from the interference light generated by the second low coherence light in the measurement initiating position adjusting mode.

Further, the control means may have a function, in addition to the function of controlling the interference light detecting means according to the mode, of automatically controlling the optical path length adjusting means so that the optical path length difference between the reference light and the measuring light is in an interference light generating region. The “interference light generating region” means a region where the optical path length difference between the measuring light and the reference light is smaller than the coherence length and interference can occur.

The second low coherence light may be either visible light or invisible light. When the second low coherence light is visible light, the control means may control the light source unit to emit both the first low coherence light and the second low coherence light in the image obtaining mode and to emit only the second low coherence light in the measurement initiating position adjusting mode.

Further, the interference light detecting means may detect an interference light by a second low coherence light as interferogram or a beat signal in the measurement initiating position adjusting mode. When the interference light detecting means detects as a beat signal, a phase modulation means which gives a frequency difference between the measuring light and the reference light is provided and the control means drives the phase modulation means in the image obtaining mode.

In accordance with the optical tomography system of the present invention, since a control means which switches between a measurement initiating position adjusting mode in which the position in the direction of depth of the object in which tomographic image signal is to be obtained is adjusted and a tomographic image obtaining mode in which a tomographic image of the object is to be obtained is provided, and the control means controls the light source unit to emit the first low coherence light and the tomographic image to obtain the tomographic image from the interference light generated by the first low coherence light in the image obtaining mode and controls the light source unit to emit the second low coherence light and the tomographic image to obtain the tomographic image from the interference light generated by the second low coherence light in the measurement initiating position adjusting mode, the distance to the object is measured by TD-OCT measurement by the use of the interference light by the second low coherence light not by the first low coherence light and obtains a tomographic image to determine the position of the object when setting the measurement initiating position from which a tomographic image is to be obtained in the measurement initiating position adjusting mode. Accordingly, the time required for the signal processing to detect the measurement initiating position can be shortened and adjustment of the measurement initiating position can be carried out in a short time.

When the control means controls the optical path length adjusting means so that the optical path length difference between the reference light and the measuring light is in an interference light generating region in the measurement initiating position adjusting mode, the optical path length can be automatically carried out, whereby the tomographic image signal can be efficiently obtained and the measurement initiating position can be surely adjusted.

Further, when the second low coherence light is visible light, and the control means controls the light source unit to emit the first low coherence light and the second low coherence light in the image obtaining mode and to emit only the second low coherence light in the measurement initiating position adjusting mode, since low coherence light functions as the guiding light (aiming light) in the image obtaining mode, the measured part where a tomographic image is obtained can be easily checked on the basis of the low coherence light.

When a phase modulation means which gives a frequency difference between the measuring light and the reference light is further provided and the control means drives the phase modulation means in the image obtaining mode, the interference light detecting means can detect the interference light as a beat signal that varies in intensity at the frequency difference, whereby the time required for adjustment of the measurement initiating position can be further shortened.

### BRIEF DESCRIPTION OF THE DRAWINGS

FIG. 1 is a schematic diagram showing an optical tomography system in accordance with a preferred embodiment of the present invention, and

FIG. 2 is a schematic diagram showing an optical tomography system in accordance with a second embodiment of the present invention.

### DESCRIPTION OF THE PREFERRED EMBODIMENTS

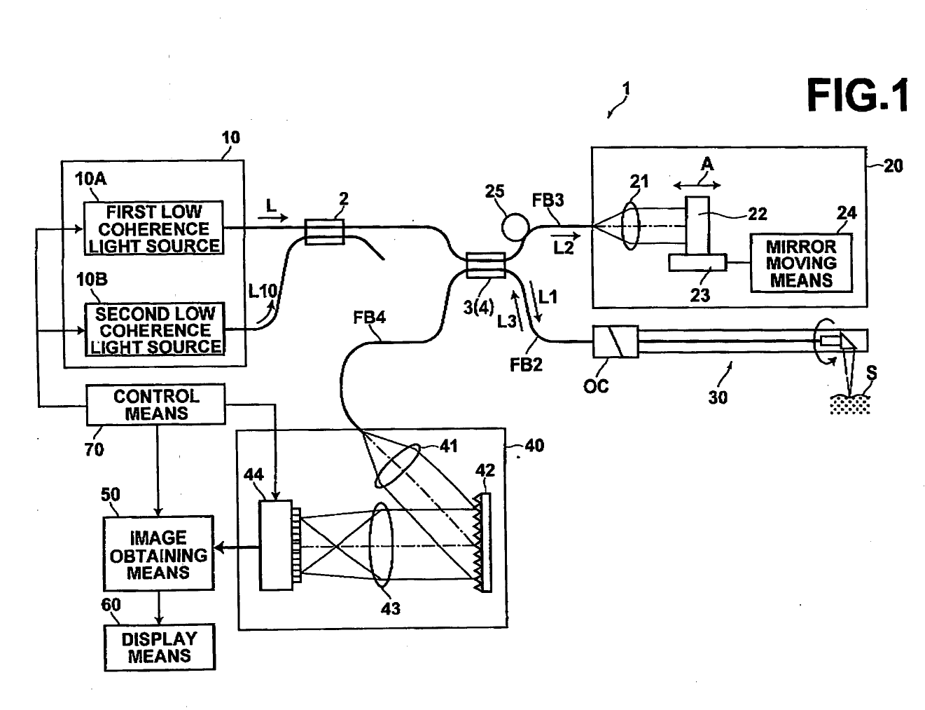

Embodiments of the optical tomography system of the present invention will be described in detail with reference to the drawings, hereinbelow. FIG. 1 is a schematic diagram that illustrates an optical tomography system in accordance with a preferred embodiment of the present invention. The optical tomography system 1 of this embodiment is for obtaining a tomographic image of an object of measurement such as a living tissue or a cell in a body cavity by measuring the SD-OCT. The optical tomography system 1 of this embodiment comprises: a light source unit 10 which emits first low coherence light L or second low coherence light; a light dividing means 3 which divides the first or second low coherence light L or L10 emitted from the light source unit 10 into measuring light L1 and reference light L2; an optical path length adjusting means 20 which adjusts the optical path length of the reference light L2 divided by the light dividing means; a probe 30 which guides to the object S to be measured the measuring light beam L1 divided by the light dividing means 3; a multiplexing means 4 for multiplexing a reflected light beam L3 from the object S when the measuring light beam L1 is irradiated onto the object S from the probe 30, and the reference light beam L2; an interference light detecting means 40 for detecting interference light beam L4 of the reflected light beam L3 and the reference light beam L2 which have been multiplexed by the multiplexing means 4; and an image obtaining means 50 which detects intensities the interference light L4 in positions in the direction of depth of the object by carrying out frequency-analysis on the interference light L4 detected by the interference light detecting means and obtains a tomographic image of the object S.

The light source unit 10 comprises a first low coherence light source 10A which emits first low coherence light beam L and a second low coherence light source 10B which emits second low coherence light beam L10. The first low coherence light source 10A is a light source which emits first low coherence light L such as SLD (super luminescent diode) or ASE (amplified spontaneous emission) and enters the first low coherence light beam L into an optical fiber FB1 by way of a fiber optic coupler 2. Since the optical tomography system 1 is for obtaining a tomographic image of an organic body in a body cavity of the object S, it is preferred that the first low coherence light source 10A emits a broad spectral band, ultra short pulse light beam where attenuation of light beam due to scatter and/or absorption when transmitted through the object S is minimized.

Whereas, the second low coherence light source 10B emits second low coherence light beam L10 which is longer in coherence length than the first low coherence light beam L and comprises, for instance, SLD (super luminescent diode) or ASE (amplified spontaneous emission). The optical characteristics of the SLD (e.g., the light intensity, time coherence or the spectral width) changes depending upon the temperature of the electric current injected into the SLD or the temperature of the SLD. Accordingly, when the first low coherence light source 10A and the second low coherence light source 10B are both of the SLDs, the SLD forming the second low coherence light source 10B is controlled so that the second low coherence light beam L10 is longer in coherence length than the first low coherence light beam L.

The light dividing means 3 comprises, for instance, a 2×2 fiber optic coupler and divides the first low coherence light beam L or the second low coherence light beam L10 led thereto by way of the optical fiber FB1 from the light source unit 10 into the measuring light beam L1 and the reference light beam L2. The light dividing means 3 is optically connected to two optical fibers FB2 and FB3, and the measuring light beam L1 is propagated through the optical fiber FB2 while the reference light beam L2 is propagated through the optical fiber FB3. In FIG. 1, the light dividing means 3 also functions as the multiplexing means 4.

The probe 30 is optically connected to the optical fiber FB2 and the measuring light beam L1 is guided to the probe 30 from the optical fiber FB2. The probe 30 is inserted into a body cavity, for instance, through a forceps port by way of a forceps channel and is removably mounted on the optical fiber FB2 by an optical connector OC.

The optical path length adjusting means 20 is disposed on the side of the optical fiber FB3 radiating the reference light beam L2. The optical path length adjusting means 20 changes the optical path length of the reference light beam L2 in order to adjust the measurement initiation position with respect to the object S and comprises a collimator lens 21 and a reflecting mirror 22. The reference light beam L2 radiated from the optical fiber FB3 is reflected by the reflecting mirror 22 after passing through the collimator lens 21 and reenters the optical fiber FB3 again through the collimator lens 21.

The reflecting mirror 22 is disposed on a movable stage 23 which is moved in the direction of arrow A by a mirror moving means 24. In response to movement of the movable stage 23 in the direction of arrow A, the optical path length of the reference light beam L2 is changed.

The multiplexing means 4 comprises a 2×2 fiber optic coupler, and multiplexes the reference light beam L2 which has been changed in its optical path length and shifted in its frequency by the optical path length adjusting means 20 and the reflected light beam L3 from the object S to emit the multiplexed light beam toward an interference light detecting means 40 by way of an optical fiber FB4.

The interference light detecting means 40 detects interference light beam L4 of the reflected light beam L3 and the reference light beam L2 which have been multiplexed by the multiplexing means 4 and comprises a spectral means 42 which spectrally divides the interference light beam L4 having a predetermined wavelength band by the wavelength band, a light detecting means 44 which detects the amount of light by the wavelengths of the interference light beam L4 divided by the spectral means 42, and a lens 43 which is disposed between the first light detecting means 44 and the spectral means 42 and images the interference light beam L4 spectrally divided by the spectral means 42 on the light detecting means 44.

The spectral means 42 comprises, for instance, a diffraction grating element, and divides the interference light beam L4 entering it from an optical fiber FB4 by way of a collimator lens 41 to emit the divided interference light beam L4 to the light detecting means 44. The lens 43 collects the divided interference light beam L4 divided by the spectral means 42 on the light detecting means 44. The light detecting means 44 has structure comprising a plurality of one-dimensionally arranged photo-sensors such as CCDs or photodiodes and the photo-sensors detect the interference light beam L4 impinging thereupon by way of the lens 43 by the wavelength band. In the light detecting means 44, the interference light beam L4 where Fourier-transformed function of information on the reflection is added to the spectrum of the measuring light beam L1 is observed. The light detecting means 44 has such a spectral sensitivity that it can detect both the wavelength band of the first low coherence light beam L and the wavelength band of the second low coherence light beam L10.

The image obtaining means 50 obtains information on reflection of the positions in the direction of depth of the object S by carrying out frequency analysis on the interference light beam L4 detected by the interference light detecting means 40. The image obtaining means 50 obtains an image of the object S by using the intensities of the reflected light beam L3 in positions in the direction of depth of the object S. Then the tomographic image is displayed in a display 60.

Here, detection of the interference light beam L4 in the interference light detecting means 40 and image generation in the image obtaining means 50 will be described briefly. Note that a detailed description of these two points can be found in M. Takeda, “Optical Frequency Scanning Interference Microscopes”, Optical Engineering Contact, Vol. 41, No. 7, pp. 426-432, 2003.

When the measuring light beam L1 having a spectral intensity distribution of S(k), the light intensity I(k) detected in the interference light detecting means 40 as the interferogram is expressed by the following formula.
I(I)=∫₀^{∞}S(k)[l+cos(kl)]dk (1)
wherein k represents the angular frequency and l represents the optical path length difference between the measuring light beam L1 and the reference light beam L2. Formula (1) expresses how much components of the angular frequency k of the interference fringe I(I) are included in the interference fringe I(I) where the spectral intensity distribution of each spectral component is S(k). Further, from the angular frequency k of the interference light fringes, the optical path length difference between the measuring light beam L1 and the reference light beam L2, that is, information on the position of depth, is given. Accordingly, S(k) of the interference light beam L4 can be obtained by carrying out frequency analysis by Fourier-transform on the interferogram detected by the interference light detecting means 40 in the image obtaining means 50. Then a tomographic image is generated by obtaining information on the distance of the object S from the measurement initiating position and information on the intensity of reflection. The generated tomographic image is displayed in the display 60.

Operation of the optical tomography system 1 will be described with reference to FIG. 1, hereinbelow. When a tomographic image is to be obtained, the optical path length is first adjusted by moving the movable stage 23 in the direction of the arrow A so that the object S is positioned in the measurable area. The first low coherence light beam L is subsequently emitted from the light source unit 10 and the first low coherence light beam L is divided into the measuring light beam L1 and the reference light beam L2 by the light dividing means 3. The measuring light beam L1 is led by the optical probe 30 into a body cavity and is projected onto the object S. Then the reflected light beam L3 from the object S and the reference light beam L2 reflected by the reflecting mirror 22 are multiplexed, and the interference light beam L4 of the reflected light beam L3 and the reference light beam L2 is detected by the interference light detecting means 40. A tomographic image is obtained by carrying out frequency analysis on a signal of the detected interference light beam L4 in the image obtaining means 50. In the optical tomography system 1 where a tomographic image is obtained by the SS-OCT measurement, the image information in positions in the direction of depth is obtained on the basis of the frequency and the intensity of the interference light beam L4 and the movement of the reflecting mirror 22 in the direction of arrow A is used for adjustment of the position in which a tomographic image is to be obtained in the direction of depth of the object S.

In the case where the measurement initiating position is adjusted by moving the reflecting mirror 22 in the arrow A, steps of first moving the reflecting mirror, carrying out detection of the reflected light beam L4 when the reflecting mirror 22 is in the position and signal processing such as frequency-analysis on the detected reflected light beam L4, and thereafter readjusting the position of the reflected mirror is necessary. That is, what kind of interference light beam is detected in the new position of the reflecting mirror cannot be known until the signal processing is carried out, whereby adjustment of the measurement initiating position requires a long time.

Accordingly, in the optical tomography system of FIG. 1, there is provided a control means 70 which switches between a measurement initiating position adjusting mode where the position in which a tomographic image is to be obtained is adjusted in the direction of depth of the object S and an image obtaining mode where an image of the object S is obtained so that the system is switched to the image obtaining mode after the position in which a tomographic image is to be obtained is adjusted in the measurement initiating position adjusting mode and a tomographic image is obtained. The control means 70, in the measurement initiating position adjusting mode, controls the light source unit 10 to emit the low coherence light L10 and controls the interference light detecting means 40 and the image obtaining means 50 to effect the TD-OCT measurement where the direction of depth of measurement changes in response to movement of the reflecting mirror 22 to obtain a tomographic image signal.

Specifically, a phase modulating means 25 such as a piezoelectric element which shifts the frequency of the reference light beam L2 is provided in the optical fiber FB3. In the measurement initiating position adjusting mode, the control means 70 drives the phase modulating means 25 and controls so that the interference light detecting means 40 and the image obtaining means 50 detect the interference light beam L4 by the second low coherence light beam L10 by heterodyne detection. Thereby the second low coherence light beam L10 emitted from the light source unit 10 is divided into the measuring light beam L1 and the reference light beam L2 by the light dividing means 3, and the reflected light beam L3 from the object S is multiplexed with the reference light beam L2 by the multiplexing means 4 to generate the interference light beam L4. At this time, the reflecting mirror 22 of the optical path length adjusting means 22 is moved in the direction of arrow A to change the optical path length of the reference light beam L2.

In the interference light detecting means 40, a beat signal which repeats strength and weakness at the frequency difference between the reflected light beam L3 and the reference light beam L2 is detected as a signal of the interference light beam L4 when the optical path lengths of the measuring light beam L1 and the reference light beam L2 are equal to each other. The image obtaining means 50 obtains a tomographic image signal from the interference light beam L4. As the optical path length is changed by the optical path length adjusting means 20, the optical path length difference between the measuring light beam and the reference light beam changes and when the optical path lengths of the measuring light beam and the reference beam light come to conform to each other, the beat signal is detected.

The optical path length adjusting means 20 may be arranged to cause the control means to automatically adjust the optical path length at this time. At this time, the optical path length adjusting means 20 is controlled so that the optical path length difference between the reference light beam L2 and the measuring light beam L1 is in an interference light generating region. The “interference light generating region” means a region where such an interference that the optical path length difference Δ1 between the measuring light beam L1 and the reference light beam L2 is smaller than the coherence length takes place.

After the adjustment of the measurement initiating position, the control means 70 switches from the measurement initiating position adjusting mode to the image obtaining mode and a tomographic image is obtained. At this time, the control means 70 controls so that the first low coherence light beam L is emitted from the light source unit 10 and the interference light detecting means 40 and the image obtaining means 50 detect the interference light L4 on which the reflection information in the positions in the direction of depth is superposed. Then the image obtaining means 50 obtains a tomographic image on the basis of the interference light beam L4 detected by the interference light detecting means 40.

By the SD-OCT measurement, where it is not necessary to move the reflecting mirror 22 to obtain a tomographic image, a tomographic image can be obtained at a higher speed than by the TD-OCT measurement. However, the TD-OCT measurement is wider than the SD-OCT measurement in the measurable range. On the other hand, the tomographic image need not be of a high resolution when the measurement initiating position is adjusted. Accordingly, by detecting the object to adjust the optical path length by the TD-OCT measurement in the measurement initiating position adjusting mode, the object S can be easily imaged in a tomographic image and the signal processing can be effected in a short time, whereby the optical path length can be adjusted simply at high speed.

Though only the first low coherence light L is emitted in the above embodiment in the image obtaining mode, the second low coherence light L10 in the form of visible light may be emitted together with the first low coherence light L and the interference light detecting means 40 may detect only the interference light L4 based on the first low coherence light L. At this time, the second low coherence light L10 functions as the guiding light. Accordingly, when the probe 30 is inserted into a body cavity, the position of the probe 30 can be known on the basis of the guiding light.

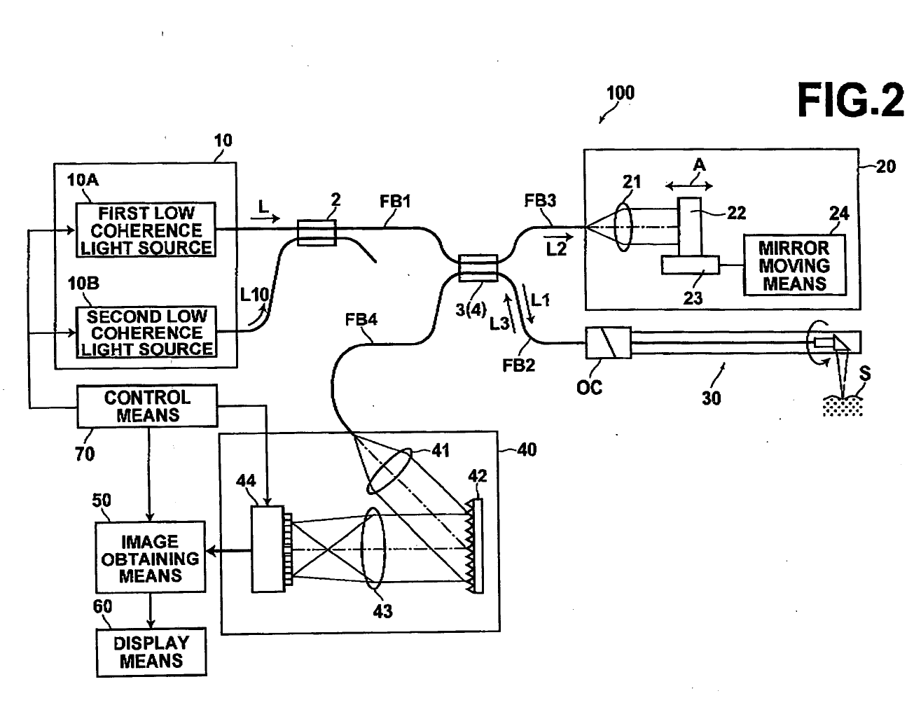

Though, in the measurement initiating position adjusting mode in the above embodiment, the interference light L4 by the second low coherence light L10 is detected as a beat signal, the interference light beam L4 may be detected as an interferogram by not providing the phase modulating means 25 in the optical path of the reference light beam L2 (e.g., the optical fiber FB3) as shown in FIG. 2.

Further, though the optical path length adjusting means 20 adjusts the optical path length of the reference light beam L2 in FIG. 1, the optical path length adjusting means 20 may adjust the optical path length of the measuring light beam L. In this case, the above said optical path length adjusting means 20 is interposed, for instance, in the optical fiber FB2 for guiding the measuring light beam L1 and the mirror in the optical fiber FB3 is fixed.

In accordance with the above embodiments, since the control means 70 switches between a measurement initiating position adjusting mode where the position in which a tomographic image starts to be obtained is adjusted in the direction of depth of the object S and an image obtaining mode where an image of the object S is obtained and the control means 70 controls the light source unit 10 so that the first low coherence light L is emitted from the first low coherence light source 10A in the image obtaining mode, and the second low coherence light L10 is emitted from the second low coherence light source 10B in the measurement initiating position adjusting mode, the measurement initiating position can be efficiently and simply adjusted on the basis of the tomographic images.

What is claimed is:

1. An optical tomography system for obtaining a tomographic image of an object to be measured comprising
a light source unit provided with a first light source which emits first low coherence light and a second light source which emits second low coherence light which is longer in the coherence length than the first low coherence light emitted from the first light source,
a light dividing means which divides the first or second low coherence light emitted from the light source unit into measuring light and reference light,
an optical path length adjusting means which adjusts the optical path length of the measuring light or the reference light divided by the light dividing means,
a multiplexing means which multiplexes the reflected light from the object when the measuring light divided by the light dividing means is projected onto the object and the reference light,
an interference light detecting means which detects interference light of the reflected light and the reference light which have been multiplexed by the multiplexing means,
a tomographic image obtaining means which detects intensities of reflection of the measuring light in positions in the direction of depth of the object by carrying out frequency-analysis on the interference light detected by the interference light detecting means and obtains a tomographic image of the object, and
a control means which switches between a measurement initiating position adjusting mode in which the position in the direction of depth of the object in which tomographic image signal is to be obtained is adjusted and a tomographic image obtaining mode in which a tomographic image of the object is to be obtained,
the control means controlling the light source unit to emit the first low coherence light and the tomographic image obtaining means to obtain the tomographic image from the interference light generated by the first low coherence light in the image obtaining mode and controlling the light source unit to emit the second low coherence light and the tomographic image obtaining means to obtain the tomographic image from the interference light generated by the second low coherence light in the measurement initiating position adjusting mode.

2. An optical tomography system as defined in claim 1 in which the control means controls the optical path length adjusting means so that the optical path length difference between the reference light and the measuring light is in an interference light generating region.

3. An optical tomography system as defined in claim 1 in which the second low coherence light is visible light and the control means controls the light source unit to emit both the first low coherence light and the second low coherence light in the image obtaining mode and to emit only the second low coherence light in the measurement initiating position adjusting mode.

4. An optical tomography system as defined in claim 1 further comprising a phase modulation means which gives a frequency difference between the measuring light and the reference light in which the control means drives the phase modulation means in the image obtaining mode.
